(19) United States
(12) Patent Application Publication
(10) Pub. No.: US 2015/0001979 A1
(43) Pub. Date: Jan. 1, 2015

(54) Axial Gap Rotating Electric Machine

(71) Applicant: Hitachi, Ltd., Tokyo (JP)

(72) Inventors: Kenta DEGUCHI, Tokyo (JP); Hirooki TOKOI, Tokyo (JP); Yuji ENOMOTO, Tokyo (JP)

(21) Appl. No.: 14/314,214

(22) Filed: Jun. 25, 2014

(30) Foreign Application Priority Data
Jun. 28, 2013 (JP) 2013-135867

(51) Int. Cl. H02K 1/18; H02K 1/27

(52) U.S. Cl. CPC H02K 1/182; H02K 1/2793
USPC 310/156.37

(57) ABSTRACT

An axial gap rotating electric machine includes a pair of rotors fixed to a rotating shaft, a stator, a holding member holding the stator, and a housing. The stator includes cores arranged in a circumferential direction of the rotating shaft, and coils wound around the cores. The holding member and the housing are conductive. The holding member includes an outer peripheral portion firmly fixed on an inner wall of the housing, and a protruding portion protruding from the outer peripheral portion toward the rotating shaft. The protruding portion includes a plurality of protruding portions in the circumferential direction of the rotating shaft. The core is held by a pair of the protruding portions adjacent in the circumferential direction of the rotating shaft, and a gap to interrupt a path of eddy currents between distal ends of the pair of the protruding portions is provided between the distal ends.

### CROSS-REFERENCE TO RELATED APPLICATIONS

This application claims the priority of Japanese Patent Application No. 2013-135867, filed on Jun. 28, 2013, which is incorporated herein by reference in its entirety.

### BACKGROUND OF THE INVENTION

1. Field of the Invention

The present invention relates to an axial gap rotating electric machine.

2. Description of the Related Art

An axial gap rotating electric machine of a two rotor-one stator type is known, which has a structure in which a pair of disc-shaped rotors is arranged in an axial direction of a rotating shaft in such a manner as to face each other, and a stator is sandwiched between the pair of rotors via a predetermined gap (see JP-2008-245504-A).

In the axial gap rotating electric machine of the two rotor-one stator type, a plurality of stator cores constituting the stator is arranged around the rotating shaft between the pair of rotors. Hence, the stator cores need to be held on the outside of the stator cores in the circumferential direction. JP-2008-245504-A describes an axial gap rotating electric machine in which a stator core (teeth) around which stator coils are wound is fitted in notches provided on the outer side of a disc-shaped holding member (back yoke) in a radial direction, and the holding member (back yoke) is attached to a housing (casing) by press fitting or shrink fitting (see FIGS. 15 and 16 of JP-2008-245504-A).

### SUMMARY OF THE INVENTION

In the rotating electric machine illustrated in FIGS. 15 and 16 of JP-2008-245504-A, when magnetic flux produced by the stator coils acts on the stator core (teeth), eddy currents are generated around the stator core (teeth) with the holding member and housing as paths.

An axial gap rotating electric machine according to a first aspect of the present invention includes: a pair of rotors fixed to a rotating shaft; a stator between the pair of rotors; a holding member holding the stator; and a housing for housing the pair of rotors, the stator, and the holding member, wherein the stator includes a plurality of cores arranged in a circumferential direction of the rotating shaft, and coils wound around the cores, the holding member and the housing are conductive, the holding member includes an outer peripheral portion firmly fixed on an inner wall of the housing, and a protruding portion protruding from the outer peripheral portion toward the rotating shaft, the protruding portion includes a plurality of protruding portions in the circumferential direction of the rotating shaft, the core is held by a pair of the protruding portions adjacent in the circumferential direction of the rotating shaft, and a gap to interrupt a path of eddy currents between distal ends of the pair of the protruding portions is provided between the distal ends.

The present invention can suppress the generation of eddy currents and promote improvement in motor efficiency.

### BRIEF DESCRIPTION OF THE DRAWINGS

FIG. 1 is a perspective view of the configuration of an axial gap rotating electric machine according to a first embodiment of the present invention;

FIG. 2 is a sectional schematic diagram of the axial gap rotating electric machine according to the first embodiment of the present invention as viewed from a direction orthogonal to a rotating shaft;

FIG. 3 is a perspective view of the configuration of a core;

FIG. 4 is a sectional schematic diagram of the axial gap rotating electric machine as viewed from an axial direction of the rotating shaft;

FIG. 5 is a partial perspective view of a holding member firmly fixed on a center bracket of a housing;

FIGS. 6A and 6B are diagrams illustrating a method for attaching a stator to the holding member;

FIG. 7A is a partial flat schematic diagram of the axial gap rotating electric machine according to the embodiment, and FIG. 7B is a diagram illustrating a comparative example of FIG. 7A;

FIGS. 8A and 8B are diagrams illustrating a method for attaching, to a holding member, a core applied to an axial gap rotating electric machine according to a second embodiment of the present invention;

FIGS. 9A and 9B are diagrams illustrating a method for attaching a snap ring to a core applied to an axial gap rotating electric machine according to a third embodiment;

FIGS. 10A and 10B are diagrams illustrating a method for attaching the core with the snap ring of FIG. 9B to a holding member;

FIG. 11 is a sectional schematic diagram of an axial gap rotating electric machine according to a fourth embodiment of the present invention as viewed from a direction orthogonal to a rotating shaft;

FIG. 12 is a partial perspective view of a holding member firmly fixed on a center bracket of a housing;

FIG. 13 is a partial sectional perspective view of a holding structure of a core;

FIG. 14 is a sectional schematic diagram of an axial gap rotating electric machine according to a fifth embodiment of the present invention as viewed from a direction orthogonal to a rotating shaft;

FIG. 15 is a partially enlarged perspective view of a holding structure of a core; and

FIG. 16 is a partially enlarged perspective view of divided holding members of an axial gap rotating electric machine according to a modification.

### DESCRIPTION OF THE PREFERRED EMBODIMENTS

Hereinafter, one embodiment of an axial gap rotating electric machine (axial gap motor) according to the present invention is described with reference to the drawings.

### First Embodiment

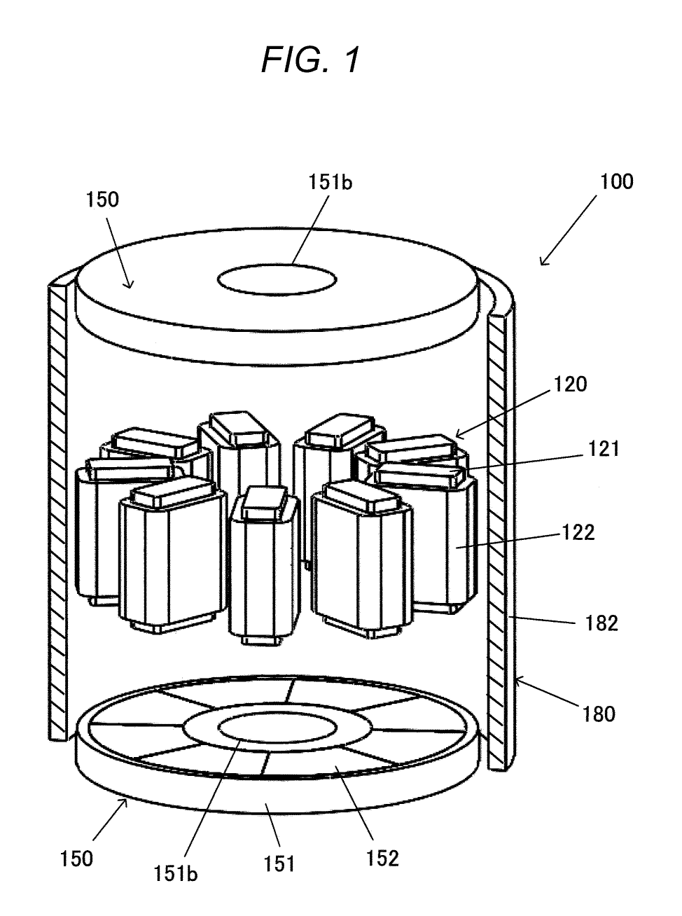

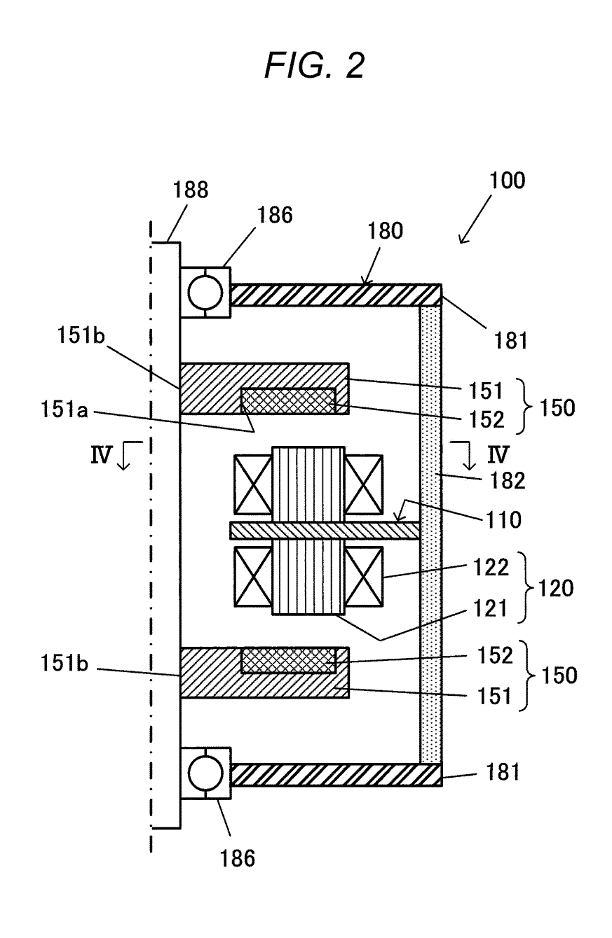

FIG. 1 is a perspective view of the configuration of an axial gap rotating electric machine according to a first embodiment of the present invention. In FIG. 1, the illustrations of a rotating shaft 188, a holding member 110 that holds stator cores 121, and end brackets 181 are omitted, and a part of a center bracket 182 is cut away. A stator coil 122 wound a plurality of times around the stator core 121 is schematically illustrated in the drawings. FIG. 2 is a sectional schematic diagram of the axial gap rotating electric machine according to the first embodiment of the present invention as viewed from a direction orthogonal to the rotating shaft 188, and illustrates a cross section on a plane that includes a center axis of the rotating shaft 188 and is parallel to an axial direction of the rotating shaft 188, the cross section having been cut at the center of a circumferential direction of a protruding portion 112 described below.

The axial gap rotating electric machine (hereinafter simply described as the motor 100) includes the rotating shaft 188 (not illustrated in FIG. 1), a pair of rotors 150 fixed to the rotating shaft 188, a stator 120 arranged between the pair of rotors 150, the holding member 110 (not illustrated in FIG. 1) that holds the stator 120, and a housing 180 that houses the pair of rotors 150, the stator 120, and the holding member 110. The motor 100 of the embodiment is an axial gap rotating electric machine of a two rotor-one stator type having a structure where the stator 120 is sandwiched between the pair of rotors 150 via a predetermined gap, can use more magnetic flux than an axial gap rotating electric machine of a one rotor-one stator type, and is advantageous in higher efficiency and higher output density.

The pair of rotors 150 is arranged, facing each other, with a predetermined space therebetween in the axial direction of the rotating shaft 188 (hereinafter also simply described as the axial direction). The pair of rotors 150 each has a similar shape and accordingly one of the rotors 150 is described as a representative. The rotor 150 is provided at the center with an axial hole 151b through which the rotating shaft 188 is inserted. The rotating shaft 188 is inserted through and fixed to the axial hole 151b and accordingly the rotor 150 is integrated with the rotating shaft 188.

The rotor 150 includes a disc-shaped structural member 151, and eight magnets 152. The structural member 151 is provided with a recess 151a (see FIG. 2) in which the magnets 152 are fitted, along a circumferential direction of the rotating shaft 188 (hereinafter also simply described as the circumferential direction). The magnets 152 are spaced evenly along the circumferential direction in the recess 151a. The magnet 152 is magnetized in the axial direction. One side in the axial direction is the south pole and the other side is the north pole. The magnets 152 are arranged in such a manner as to alternately reverse neighboring magnetic poles in the circumferential direction, that is, N, S, N, S, . . . .

When viewed from the axial direction, the magnets 152 of the rotor 150 on the upper side of the drawing and the magnets 152 of the rotor 150 on the lower side of the drawing are arranged in the same form at the same positions in the circumferential direction.

The stator 120 includes a plurality of the stator cores (hereinafter simply described as the cores 121) spaced evenly along the circumferential direction, and the stator coils (hereinafter simply described as the coils 122) respectively wound around the cores 121. The stator 120 is held by the holding member 110 (not illustrated in FIG. 1). The holding member 110 is firmly fixed on the housing 180. The holding member 110 and the housing 180 include conductive metal.

As illustrated in FIG. 2, the housing 180 includes the cylindrical center bracket 182, and the end brackets 181 that close openings at both ends of the center bracket 182. A space enclosed by the center bracket 182 and the pair of end brackets 181 serves as a housing space that houses the pair of rotors 150, the stator 120, and the holding member 110. The end brackets 181 are each provided with the through hole where the rotating shaft 188 penetrates. The through hole is provided with a bearing 186. The rotating shaft 188 is rotatably held by the bearings 186.

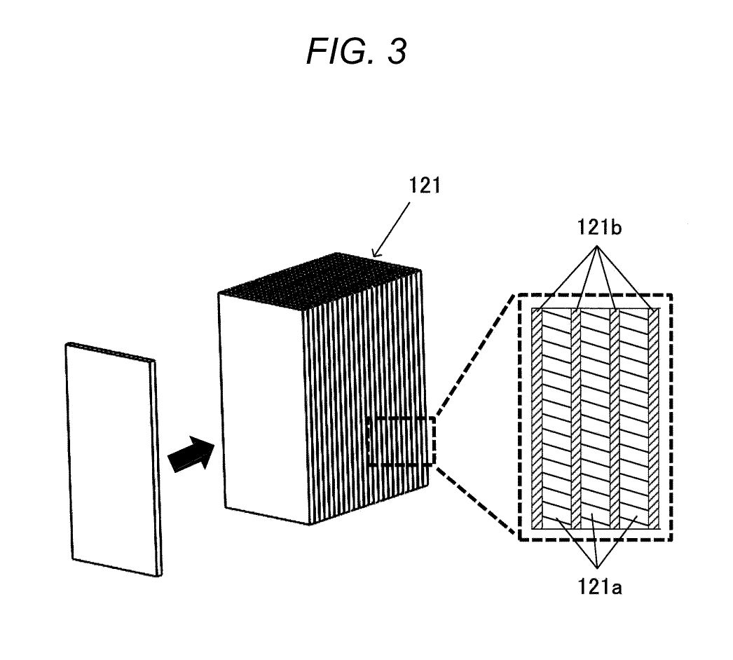

FIG. 3 is a perspective view of the configuration of the core 121. The core 121 is formed by laminating magnetic sheets 121a such as amorphous foil strips including amorphous metal or magnetic steel sheets, and has a cuboid shape. An insulating layer 121b having insulating properties is formed between the magnetic sheets 121a for the insulation between the magnetic sheets 121a. The thicknesses of the magnetic sheet 121a and the insulating layer 121b are exaggerated for illustration. In this manner, the core 121 has a laminated structure of the magnetic sheets 121a and the insulating layers 121b and accordingly the generation of eddy currents can be suppressed.

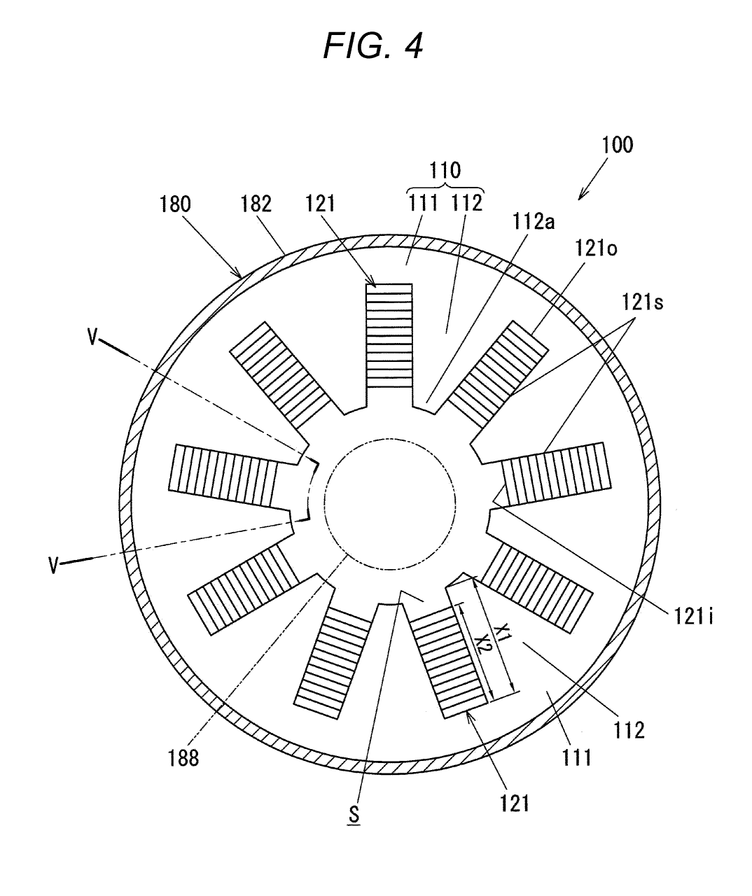

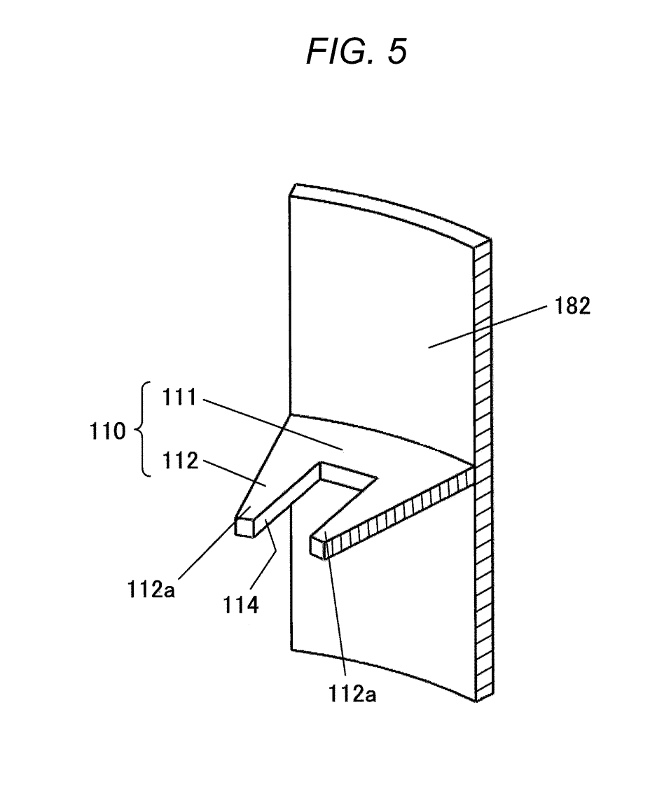

FIG. 4 is a sectional schematic diagram of the motor 100 as viewed from the axial direction, and illustrates a cross section cut along line IV-IV in FIG. 2. In FIG. 4, the illustrations of the coils are omitted. FIG. 5 is a partial perspective view of the holding member 110 firmly fixed on the center bracket 182 of the housing 180, and illustrates a perspective view cut along line V-V of FIG. 4. The holding member 110 includes a ring-shaped outer peripheral portion 111, and protruding portions 112 protruding from the outer peripheral portion 111 toward the rotating shaft 188.

The holding member 110 is attached to the center bracket 182 of the housing 180 by shrink fitting or press fitting. The outer peripheral portion 111 of the holding member 110 is firmly fixed on an inner wall of the center bracket 182. It is possible to firmly fix the holding member 110 to the center bracket 182 by shrink fitting or press fitting, and efficiently transfer the heat generated by the coil 122 and the core 121 via the holding member 110 to the housing 180. Nine protruding portions 112 are provided at predetermined intervals along the circumferential direction of the rotating shaft 188. An opening 114 (see FIG. 5) in which the core 121 is pressed is provided between the pair of protruding portions 112 adjacent in the circumferential direction.

The core 121 is attached in the opening 114 by press fitting or shrink fitting, and held by the pair of protruding portions 112 adjacent in the circumferential direction of the rotating shaft 188. The core 121 is arranged such that the magnetic sheet 121a is substantially orthogonal to the radial direction of the rotating shaft 188 (hereinafter also simply described as the radial direction). For convenience of description, as illustrated in FIG. 4, a description is given assuming that among outer peripheral surfaces of the cuboid core 121, a surface close to the rotating shaft 188 is an inner surface 121i, a surface close to the center bracket 182 of the housing 180 is an outer surface 121o, and two surfaces linking the inner surface 121i and the outer surface 121o, which are being parallel to the axial direction, are side surfaces 121s.

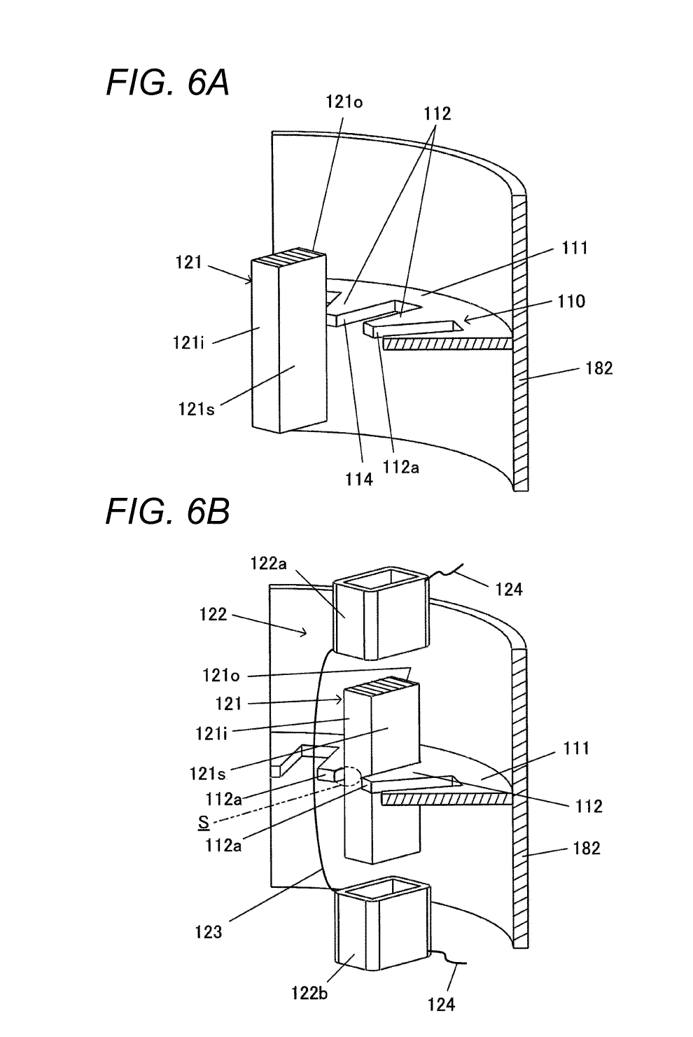

The pair of protruding portions 112 is brought into contact with center portions in the axial direction of both side surfaces 121s of the core 121, and sandwiches and holds the core 121 from both sides (see FIG. 6B). As illustrated in FIG. 4, the outer surface 1210 of the core 121 is in contact with the outer peripheral portion 111 of the holding member 110. A length (a protruding length from the outer peripheral portion 111) X1 of the protruding portion 112 in the radial direction is longer than a length X2 of the core 121 in the radial direction (the lamination direction of the magnetic sheets 121a) (X1>X2). A gap S is provided between distal ends 112a of the pair of protruding portions 112. Hence, the neighboring protruding portions 112 are not electrically connected in an area on the rotating shaft 188 side with respect to the inner surface 121i of the core 121.

An example of a method for attaching the stator 120 to the holding member 110 is described with reference to FIGS. 6A and 6B. As illustrated in FIG. 6A, the core 121 is attached by press fitting or shrink fitting in the opening 114 formed between the pair of protruding portions 112 adjacent in the circumferential direction. When the core 121 is attached in the opening 114, the core 121 is inserted outward in the radial direction from the center of the center bracket 182 as illustrated, and the outer surface 1210 of the core 121 is brought into contact with the outer peripheral portion 111. The core 121 may be attached to the holding member 110 before or after the holding member 110 is attached to the center bracket 182.

As illustrated in FIG. 6B, the coil 122 includes a pair of divided coils 122a and 122b divided in the axial direction via the holding member 110. The pair of divided coils 122a and 122b is connected by an intermediate wire 123. A wire end 124 extends from each of the divided coils 122a and 122b. Each of the divided coils 122a and 122b is formed by being previously wound around an unillustrated bobbin having insulating properties. The divided coils 122a and 122b are assembled to the core 121 to form the stator 120. The coil 122 may be wound around the core 121 without using the bobbin (not illustrated).

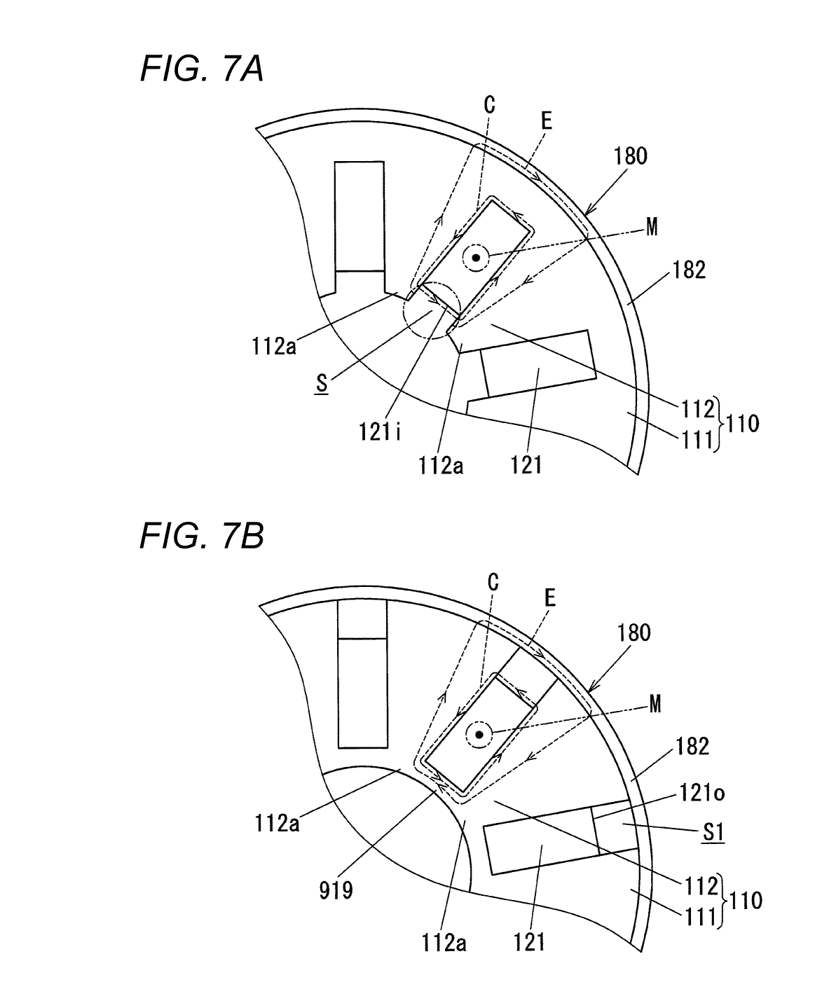

As described above, in the embodiment, the gap S is provided between the distal ends 112a of the pair of protruding portions 112. The gap S is provided to interrupt a path of eddy currents between the distal ends 112a. The operation and effect obtained by providing the gap S is specifically described compared with a comparative example. FIG. 7A is a partial flat schematic diagram of the motor 100 according to the embodiment. FIG. 7B is a diagram illustrating a comparative example of FIG. 7A. The illustration of the coil 122 is omitted in FIGS. 7A and 7B. However, an arrow C indicating the direction of current flowing through the coil 122 is schematically illustrated. Moreover, FIGS. 7A and 7B schematically illustrate an arrow M indicating the direction of magnetic flux produced by a current flowing through the coil 122, and an arrow E indicating the direction of eddy currents generated by the magnetic flux. The arrow M represents an arrow oriented from the back to the front of the space of the drawing, the arrow being vertical to the space of the drawing.

As illustrated in FIG. 7A, in the embodiment, the gap S is provided on the inner surface 121i side of the core 121 to be open between the distal ends 112a. In other words, the adjacent distal ends 112a are not electrically connected by a conductive member or the like. In contrast, as illustrated in FIG. 7B, in the comparative example, the outer peripheral portion 111 on the outer surface 1210 side is open. A gap S1 is provided between the adjacent outer peripheral portions 111 and the distal ends 112a are linked by a linking portion 919. The linking portion 919 is integrally formed with the distal ends 112a. Hence, in the comparative example, the adjacent distal ends 112a are electrically connected.

As illustrated in FIG. 7B, in the comparative example, if a current flows through the coil 122 (see the arrow C), and magnetic flux produced by the coil 122 (see the arrow M) acts on the core 121, eddy currents (see the arrow E) that produce magnetic flux to cancel the magnetic flux are generated around the core 121 with the holding member 110 and the housing 180 as paths.

In contrast, as illustrated in FIG. 7A, in the embodiment, the gap S allows the distal ends 112a of the pair of protruding portions 112 to be open therebetween, and the distal ends 112a of the protruding portions 112 are not electrically connected on the inner side (on the rotating shaft 188 side) of the core 121. In other words, the path of eddy currents between the distal ends 112a is interrupted (see the arrow E). Hence, even if a current flows through the coil 122 (see the arrow C), and the magnetic flux produced by the coil 122 (see the arrow M) acts on the core 121, the generation of eddy currents that flow around the core 121 can be suppressed. As a consequence, in the embodiment, eddy current loss can be suppressed compared with the comparative example, and improvement in motor efficiency can be promoted.

The first embodiment can obtain the following operation and effects.

(1) The gap S to interrupt the path of eddy currents between the distal ends 112a of the pair of adjacent protruding portions 112 is provided between the distal ends 112a. Hence, eddy current loss can be suppressed and improvement in motor efficiency can be promoted.

(2) The core 121 is held by the protruding portions 112 of the metal holding member 110 and accordingly the core 121 can be fixed more firmly than a case where the core 121 is held only by a mold body including resin.

### Second Embodiment

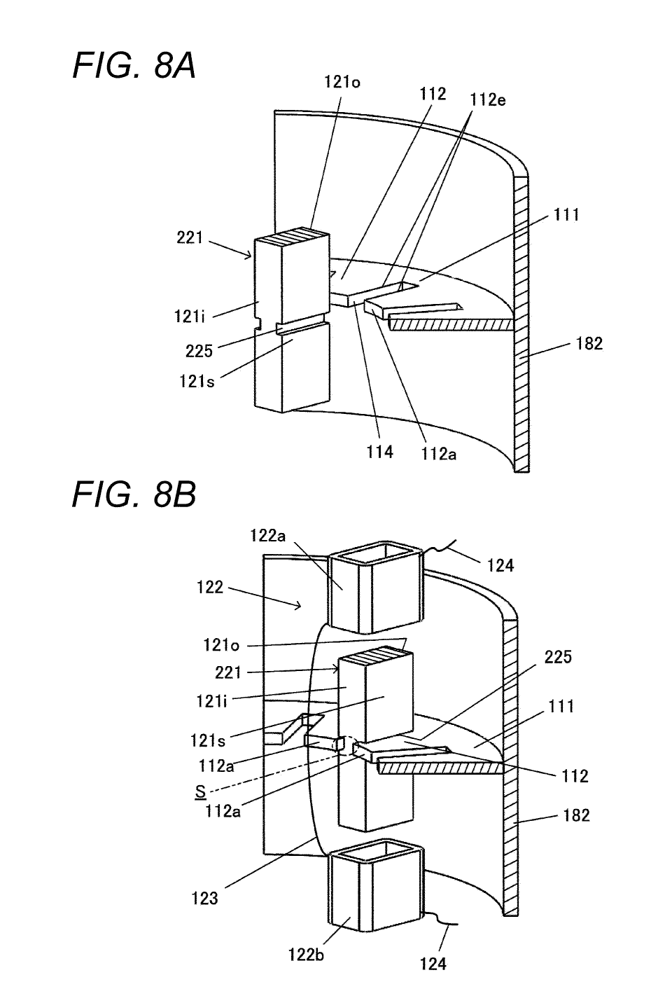

An axial gap rotating electric machine according to a second embodiment is described with reference to FIGS. 8A and 8B. FIGS. 8A and 8B are similar diagrams to FIGS. 6A and 6B, and are diagrams illustrating a method for attaching, to the holding member 110, a core 221 applied to the axial gap rotating electric machine according to the second embodiment. In the drawings, the same reference numerals are assigned to the same or equivalent parts as or to the first embodiment, and their descriptions are omitted. Hereinafter, differences from the first embodiment are described in detail.

In the second embodiment, fitting grooves 225 into which the pair of adjacent protruding portions 112 is to be fitted are formed on the side surfaces 121s of the core 221. It is preferred that a magnetic steel sheet having high processability, or the like be used for the magnetic sheet 121a to facilitate the formation of the fitting groove 225.

The fitting groove 225 extends orthogonally to the axial direction at the center of the core 221 in the axial direction. The fitting groove 225 is a part to be fitted with a circumferential outer edge 112e of the protruding portion 112 and is provided in such a manner to match the shape of the circumferential outer edge 112e of the protruding portion 112.

As illustrated in FIGS. 8A and 8B, the core 221 is inserted outward in the radial direction from the center of the center bracket 182 in such a manner to fit the circumferential outer edges 112e of the protruding portions 112 into the fitting grooves 225. The outer surface 1210 of the core 221 is brought into contact with the outer peripheral portion 111. The core 221 can be attached in the opening 114 by press fitting or shrink fitting as in the first embodiment.

As illustrated in FIG. 8B, the gap S to interrupt the path of eddy currents between the distal ends 112a of the pair of adjacent protruding portions 112 is provided between the distal ends 112a.

Such a second embodiment has the following operation and effects in addition to similar operation and effects to the first embodiment.

(3) The fitting grooves 225 to be fitted with the pair of protruding portions 112 are formed on the core 121 and accordingly the positioning accuracy of the core 121 is improved and the manufacturing efficiency is improved.

(4) The fixing strength of the core 121 in the axial direction can be further improved.

### Third Embodiment

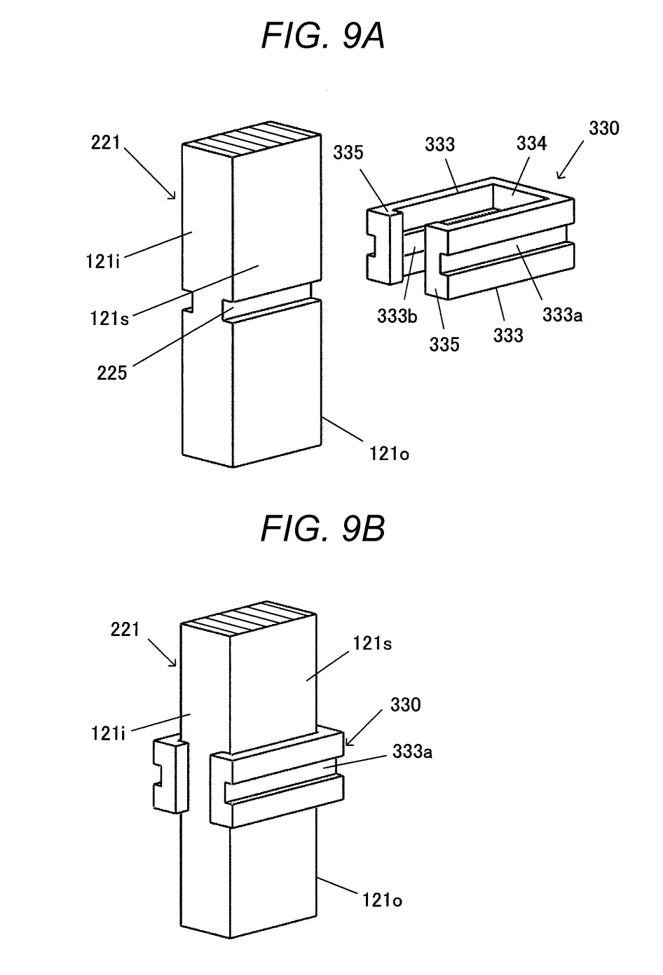

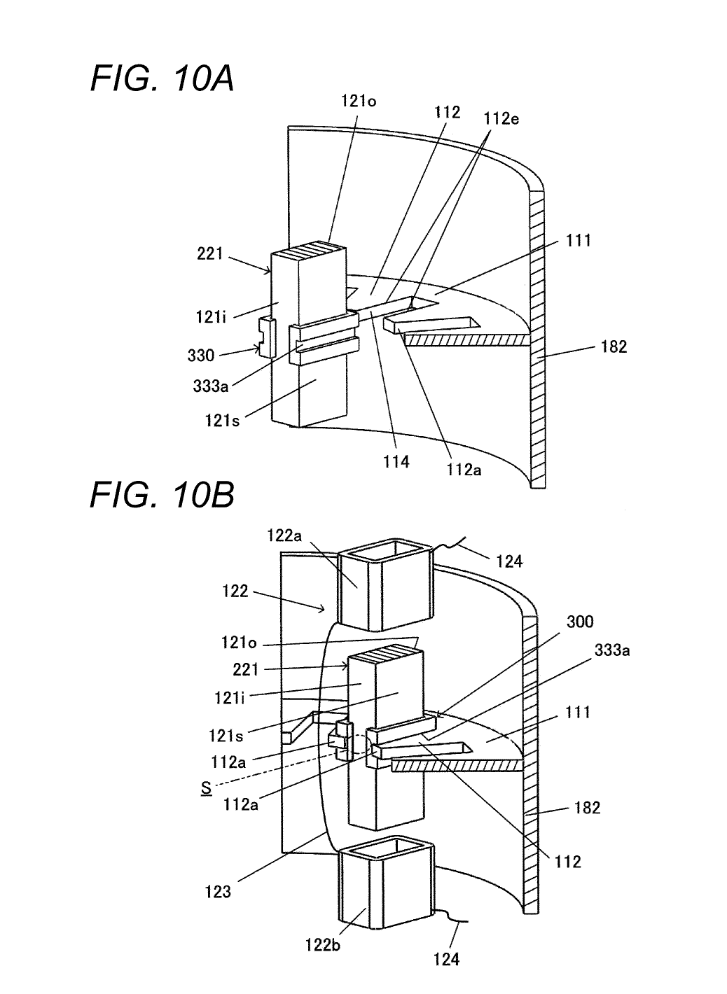

An axial gap rotating electric machine according to a third embodiment is described with reference to FIGS. 9A and 9B and 10A and 10B. FIGS. 9A and 9B are diagrams illustrating a method for attaching a snap ring 330 to the core 221 applied to the axial gap rotating electric machine according to the third embodiment. FIGS. 10A and 10B are similar diagrams to FIGS. 8A and 8B, and are diagrams illustrating a method for attaching, to the holding member 110, the core 221 with the snap ring 330 of FIGS. 9A and 9B. In the drawings, the same reference numerals are assigned to the same or equivalent parts as or to the second embodiment, and their descriptions are omitted. Hereinafter, differences from the second embodiment are described in detail.

In the third embodiment, the core 221 is attached to the holding member 110 via the snap ring 330 including resin material having insulating properties. The fitting groove 225 of the core 221 is formed in the size allowing the fit with the circumferential outer edge 112e of the protruding portion 112 in the second embodiment, but is formed in the size allowing the fit with a fitting convex portion 333b of the snap ring 330, which is described below, in the third embodiment.

As illustrated in FIG. 9A, the snap ring 330 includes an outer contact portion 334 that comes into contact with the outer surface 1210 of the core 221, a pair of side contact portions 333 that comes into contact with the side surfaces 121s of the core 221, and inner contact portions 335 that come into contact with the inner surface 121i of the core 221. The snap ring 330 has a substantial U shape in planar view.

The pair of side contact portions 333 is provided parallel to each other. One end of each of the side contact portions 333 is connected to the outer contact portion 334, and the other end of each of the side contact portions 333 is bent inward by 90 degrees to serve as the inner contact portion 335.

The fitting convex portion 333b protruding inward is formed on an inner surface of the side contact portion 333. The fitting convex portion 333b is a part to be fitted into the fitting groove 225 of the core 221, and is provided in such a manner as to match the shape of the fitting groove 225. A fitting groove 333a recessed inward is formed at a position corresponding to the fitting convex portion 333b on an outer surface of the side contact portion 333. The fitting groove 333a is a part to be fitted with the circumferential outer edge 112e of the protruding portion 112, and is provided in such a manner as to match the shape of the circumferential outer edge 112e of the protruding portion 112.

The snap ring 330 expands a space between the pair of inner contact portions 335, and is elastically deformed in such a manner as to move the pair of side contact portions 333 away from each other. Accordingly, the snap ring 330 can be attached to the core 221 as illustrated in FIG. 9B. The fitting convex portions 333b of the snap ring 330 are fitted into the fitting grooves 225 of the core 221 to fix the snap ring 330 to the core 221.

As illustrated in FIGS. 10A and 10B, the core 221 with the snap ring 330 is inserted outward in the radial direction from the center of the center bracket 182 in such a manner as to fit the circumferential outer edges 112e of the protruding portions 112 into the fitting grooves 333a of the snap ring 330. An outer surface of the outer contact portion 334 of the snap ring 330 is brought into contact with the outer peripheral portion 111.

As illustrated in FIG. 10B, the gap S to interrupt the path of eddy currents between the distal ends 112a of the pair of adjacent protruding portions 112 is provided between the distal ends 112a.

Such a third embodiment has similar operation and effects to (1) and (2) described in the first embodiment. Moreover, in the third embodiment, the fitting grooves 333a to be fitted with the pair of protruding portions 112 are formed on the snap ring 330. Hence, as in (3) described in the second embodiment, the positioning accuracy of the core 221 to which the snap ring 330 has been attached improves, and the manufacturing efficiency improves. Moreover, as in (4) described in the second embodiment, the fixing strength in the axial direction of the core 221 to which the snap ring 330 has been attached can be further improved.

Furthermore, the third embodiment has the following operation and effects in addition to the above operation and effects.

(5) The second embodiment has the configuration in which the fitting groove 225 of the core 221 comes into direct contact with the protruding portion 112. Accordingly, when the core 221 is attached in the opening 114, it is necessary to attach the core 221 in the opening 114 while taking care not to exfoliate the side surfaces 121s of the core 221. In contrast, in the third embodiment, the core 221 is held by the pair of protruding portions 112 via the snap ring 330. The side surfaces 121s of the core 221 are prevented from exfoliating due to the contact between the core 221 and the protruding portions 112. As a consequence, in the third embodiment, assembling workability is improved compared with the second embodiment.

(6) In the second embodiment, the circumferential ends of the magnetic sheets 121a constituting the core 221 and the protruding portions 112 are electrically connected. Accordingly, eddy currents are generated with the magnetic sheets 121a and the protruding portions 112 as paths. In contrast, in the third embodiment, the core 221 is covered by the snap ring 330 including resin having insulating properties. The snap ring 330 having insulating properties is arranged between the core 221 and the protruding portions 112. The core 221 and the protruding portions 112 of the holding member 110 are electrically insulated by the snap ring 330. Accordingly, the paths of eddy currents between the circumferential ends of the magnetic sheets 121a constituting the core 221 and the protruding portions 112 are interrupted. As a consequence, in the third embodiment, eddy current loss can be suppressed compared with the second embodiment, and the motor efficiency can be further improved.

### Fourth Embodiment

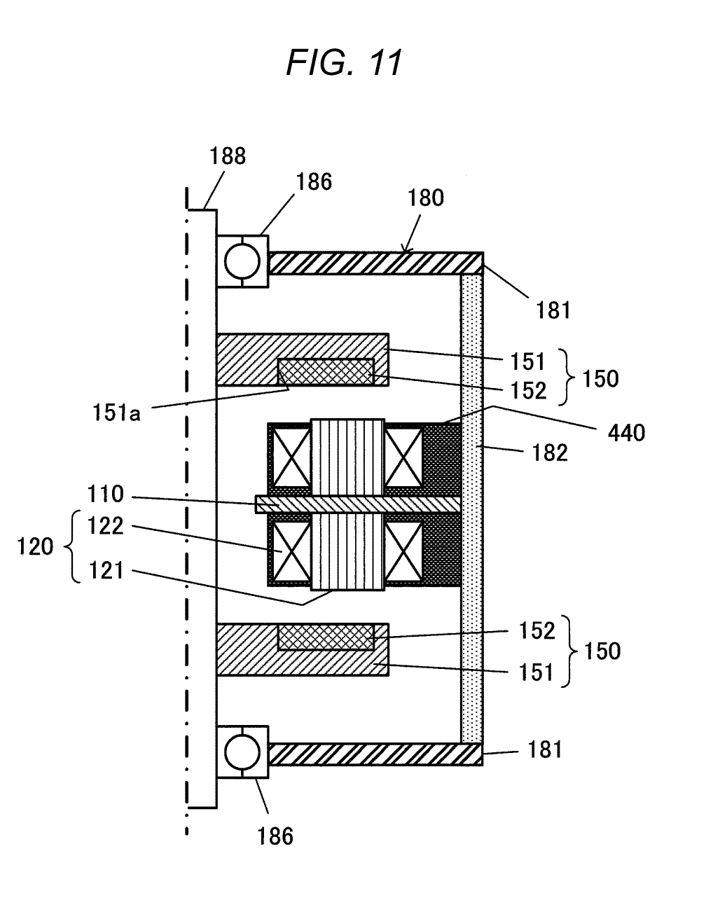

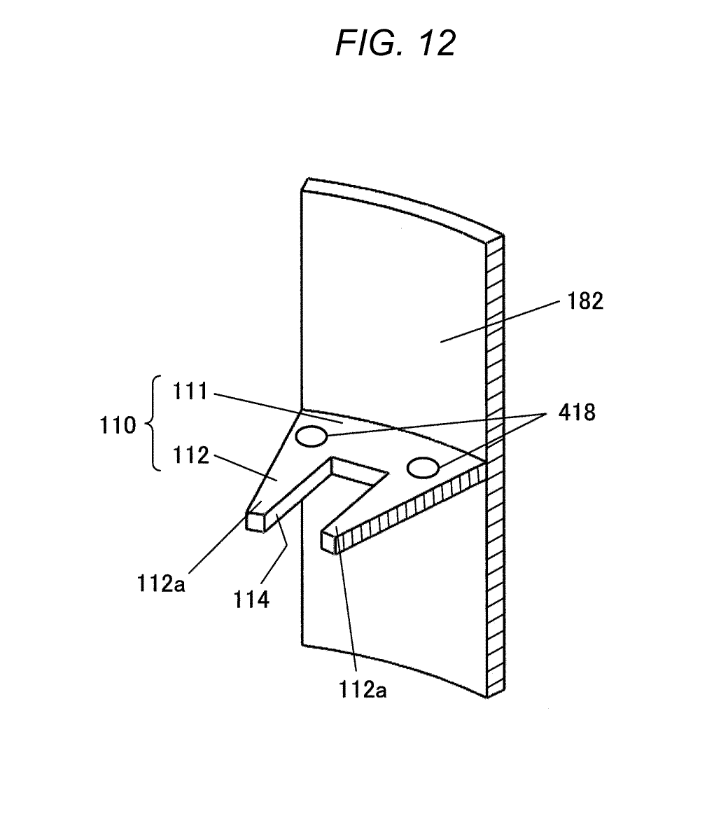

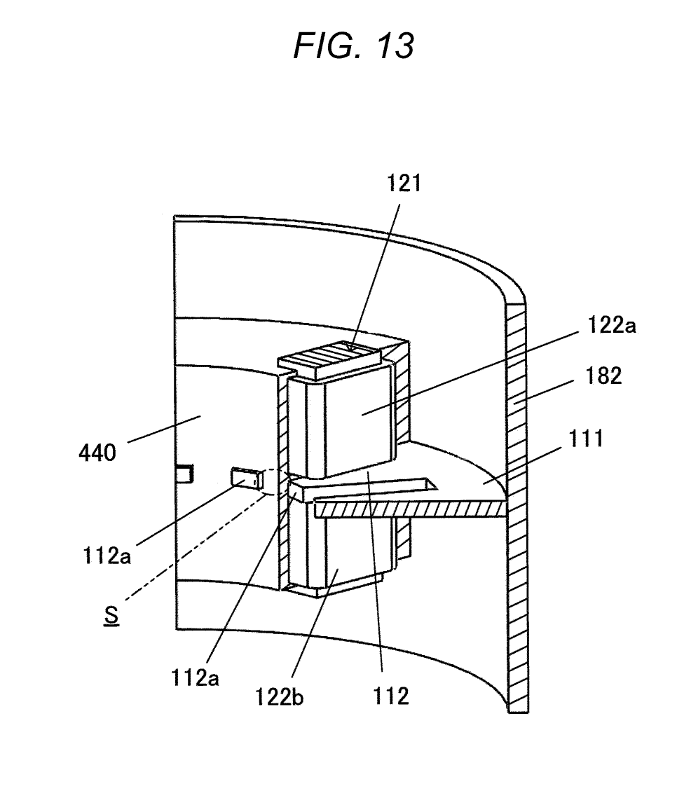

An axial gap rotating electric machine according to a fourth embodiment is described with reference to FIGS. 11 to 13. FIG. 11 is a similar diagram to FIG. 2, and is a sectional schematic diagram of the axial gap rotating electric machine according to the fourth embodiment as viewed from the direction orthogonal to the rotating shaft 188. FIG. 12 is a similar diagram to FIG. 5, and is a partial perspective view of the holding member 110 firmly fixed on the center bracket 182 of the housing 180. FIG. 13 is a partial sectional perspective view of a holding structure of the core 121. In FIG. 13, a part of a mold body 440 is cut away for illustration, and the illustrations of through holes 418 provided in the holding member 110 are omitted. In the drawings, the same reference numerals are assigned to the same or equivalent parts as or to the first embodiment, and their descriptions are omitted. Hereinafter, differences from the first embodiment are described in detail.

In the fourth embodiment, nine cores 121 and coils 122 held by the holding member 110 are integrally molded with resin having insulating properties. As illustrated in FIG. 12, the through holes 418 penetrating in the axial direction are provided in the outer peripheral portion 111 of the holding member 110. The mold body 440 including resin is formed as follows.

An assembly is prepared in which the holding member 110 is firmly fixed on the center bracket 182, the core 121 is fitted in the opening 114 of the holding member 110, and the divided coils 122a and 122b are attached to the core 121 (see FIG. 6B). The assembly is arranged such that a center axis of the center bracket 182 is parallel to the vertical direction.

Although not illustrated, an upper mold is arranged on one side (upper side) in the axial direction of the cores 121. A lower mold is arranged on the other side (lower side) in the axial direction of the cores 121. The upper and lower molds and the center bracket 182 form a resin filling space. The upper mold includes an upper disc portion with the substantially same diameter as the inside diameter of the center bracket 182, and an upper column portion protruding downward from the center of the upper disc portion. The lower mold includes a lower disc portion with the substantially same diameter as the inside diameter of the center bracket 182, and a lower column portion protruding upward from the center of the lower disc portion. The upper column portion and the lower column portion have the same diameter, and come into contact with each other at the center in the axial direction of the center bracket 182. Consequently, the substantially cylindrical filling space is formed. Heated and softened resin is injected into the filling space from an injection hole provided in the upper mold.

If the resin is injected, then the softened resin flows from an upper to a lower space of the holding member 110 via the gaps S on the inner peripheral side (on the rotating shaft 188 side) of the holding member 110. Moreover, the softened resin flows from the upper to the lower space of the holding member 110 via the through holes 418 on the outer peripheral side (on the center bracket 182 side) of the holding member 110. Consequently, the softened resin can be filled in the entire filling space. After the filling of the softened resin is complete, the resin is cured to form the mold body 440 in such a manner as to cover the cores 121 and the divided coils 122a and 122b. As illustrated in FIG. 13, the mold body 440 is shaped into a substantially cylindrical shape, and formed such that the distal ends 112a of the protruding portions 112 protrude from an inner peripheral surface of the mold body 440.

As illustrated in FIG. 13, the gap S to interrupt the path of eddy currents between the distal ends 112a of the pair of adjacent protruding portions 112 is provided between the distal ends 112a. There is the resin forming the mold body 440 between the adjacent distal ends 112a. However, as described above, the resin forming the mold body 440 has insulating properties. Accordingly, as in the first embodiment, the path of eddy currents between the adjacent distal ends 112a can be interrupted.

Such a fourth embodiment has the following operation and effects in addition to similar operation and effects to the first embodiment.

(7) The mold body 440 is formed in such a manner as to cover the cores 121 and the divided coils 122a and 122b. Consequently, the holding strength of the core 121 can be further improved. Moreover, the heat generated by the coil 122 and the core 121 can be transferred to the housing 180 via the mold body 440. Accordingly, the heat can be transferred to the housing 180 more efficiently than a case where the mold body 440 is not provided.

(8) The gap S is formed between the pair of adjacent protruding portions 112. The through hole 418 penetrating in the axial direction is formed in the outer peripheral portion 111 of the holding member 110. Hence, it is possible to pass softened resin from the space on one side to the space on the other side of the holding member 110 in the radial direction via the gaps S and the through holes 418, and easily fill the softened resin in the entire predetermined filling space, when the mold body 440 is formed.

### Fifth Embodiment

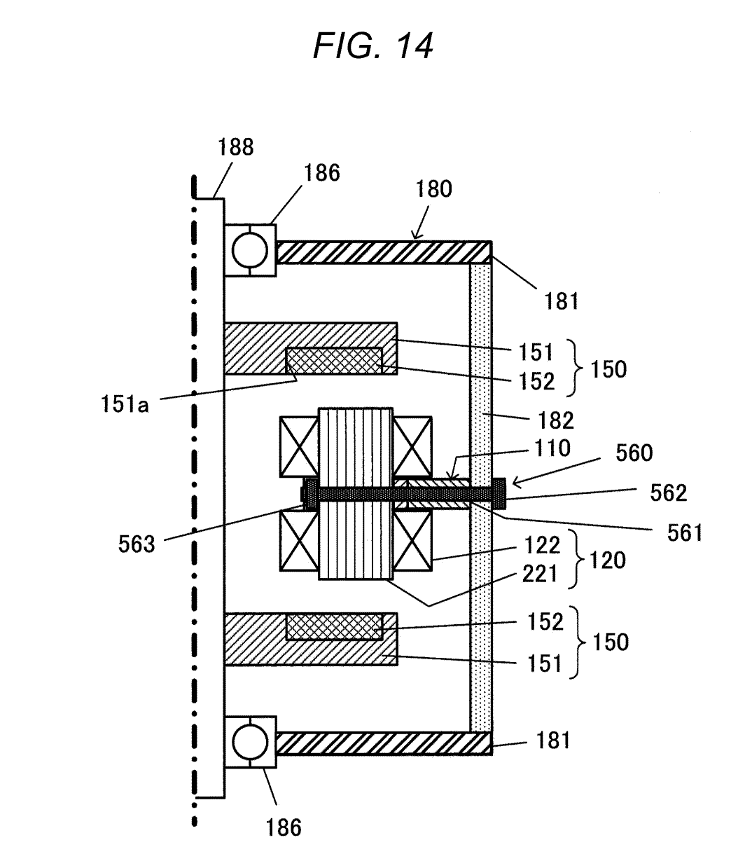

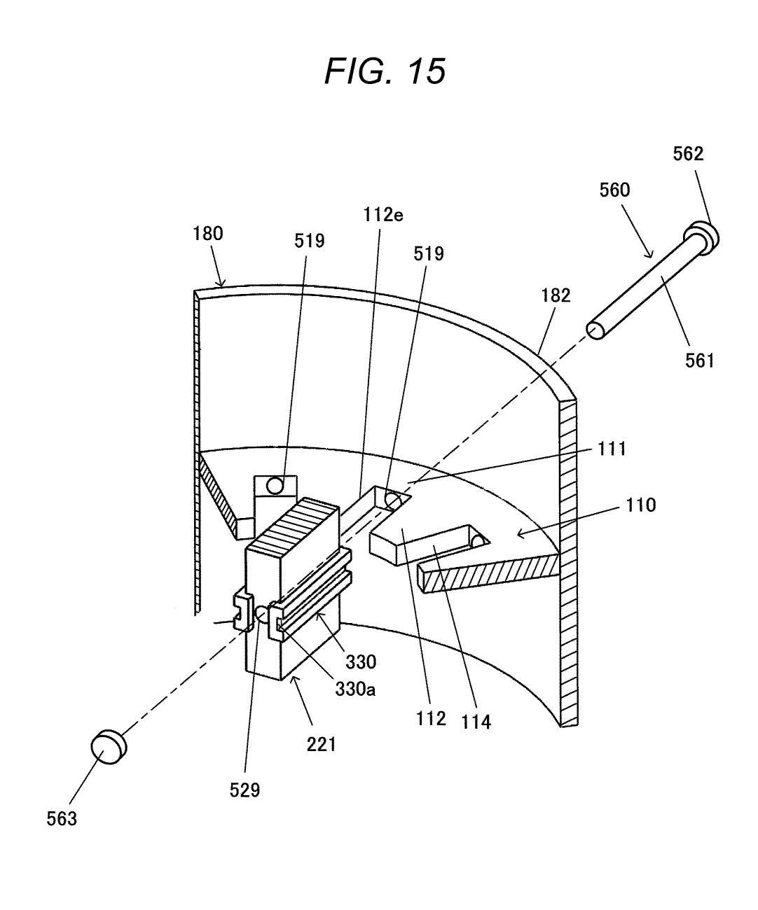

An axial gap rotating electric machine according to a fifth embodiment is described with reference to FIGS. 14 and 15. FIG. 14 is a sectional schematic diagram of the axial gap rotating electric machine according to the fifth embodiment of the present invention as viewed from the direction orthogonal to the rotating shaft 188, and illustrates a cross section on the plane that includes the center axis of the rotating shaft 188 and is parallel to the axial direction of the rotating shaft 188, the cross section having been cut at the center of the circumferential direction of the core 221. FIG. 15 is a partially enlarged perspective view of a holding structure of the core 221. In the drawings, the same reference numerals are assigned to the same or equivalent parts as or to the third embodiment, and their descriptions are omitted. Hereinafter, a difference from the third embodiment is described in detail.

The difference of the fifth embodiment from the third embodiment is in that the core 221, the holding member 110, and the center bracket 182 are fastened by a bolt 560 and a nut 563 that are fastening members. The bolt 560 includes a shank 561 and a head 562 provided at one end of the shank 561. A threaded portion to be threadedly engaged with the nut 563 is provided at the other end of the shank 561.

A through hole 529 penetrating in the lamination direction of the magnetic sheets 121a (that is, the radial direction) is provided at the center in the axial direction of the core 221. Although not illustrated, a through hole penetrating in the radial direction is also provided in the outer contact portion 334 of the snap ring 330.

A through hole 519 penetrating in the radial direction is provided in the outer peripheral portion 111 forming the opening 114 of the holding member 110. Although not illustrated, a through hole penetrating in the radial direction is also provided in the center bracket 182 at a position corresponding to the through hole 519 of the outer peripheral portion 111 of the holding member 110. The fitting grooves 333a of the snap ring 330 are fitted with the circumferential outer edges 112e of the protruding portions 112. Accordingly, the core 221 to which the snap ring 330 has been attached is attached in the opening 114 of the holding member 110 and is held by the pair of protruding portions 112.

The shank 561 of the bolt 560 is inserted in such a manner as to penetrate the through hole of the center bracket 182, the through hole 519 of the holding member 110, and the through hole of the snap ring 330, and the through hole 529 of the core 221 in the radial direction. The bolt 560 is inserted through the through holes from the outside of the center bracket 182. A distal end of the shank 561 of the bolt 560 protrudes from the inner surface 121i of the core 221. The threaded portion provided at the distal end of the shank 561 of the bolt 560 is threadedly engaged with the nut 563. Accordingly, the core 221, the holding member 110, and the center bracket 182 are sandwiched and fastened by the head 562 of the bolt 560 and the nut 563.

Such a fifth embodiment has the following operation and effects in addition to similar operation and effects to the third embodiment.

(9) The shank 561 of the bolt 560 is caused to penetrate the core 221, the holding member 110, and the housing 180 in the radial direction. The core 221, the holding member 110, and the housing 180 are fastened by the head 562 of the bolt 560 and the nut 563. Consequently, the core 221 can be fixed to the holding member 110 more firmly, and the holding member 110 can be fixed to the housing 180 more firmly.

The following modifications are also within the scope of the present invention, and one or a plurality of the modifications can also be combined with the above embodiments.

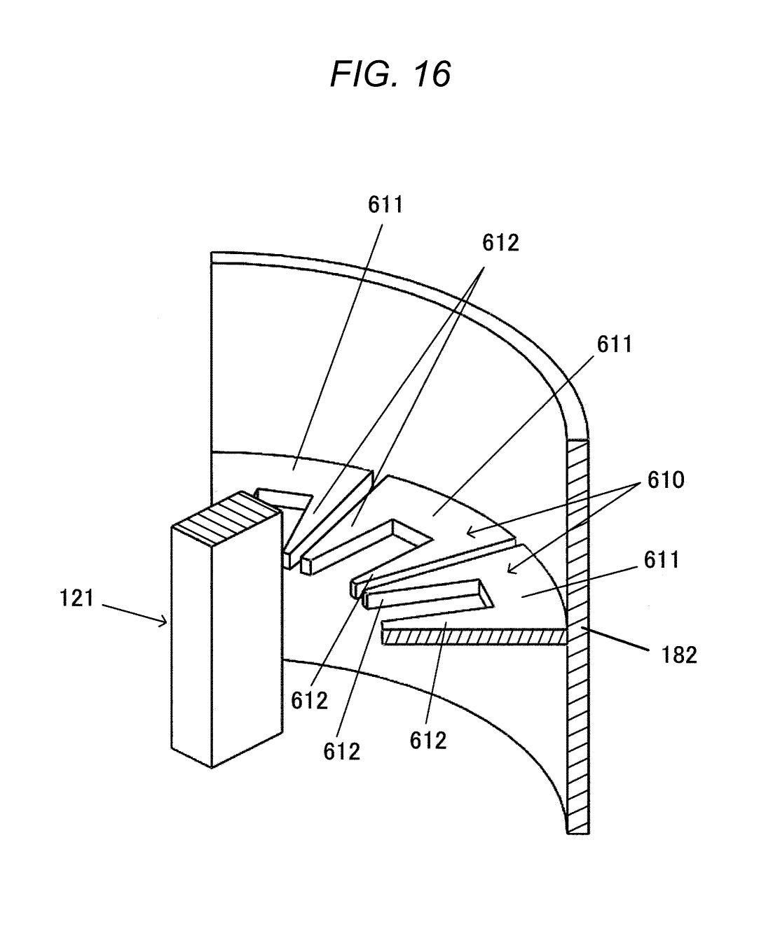

(1) The above embodiments are described taking the example where the substantially ring-shaped holding member 110 is firmly fixed by shrink fitting or press fitting. However, the present invention is not limited to the example. For example, as illustrated in FIG. 16, the substantially ring-shaped holding member 110 may be divided into a plurality of parts in the circumferential direction to form divided holding members 610. The plurality of divided holding members 610 may be fixed by welding or the like along the inner wall of the center bracket 182. The divided holding members 610 each include an outer peripheral portion 611 firmly fixed on the inner wall of the center bracket 182, and a pair or protruding portions 612 protruding from the outer peripheral portion 611 toward the rotating shaft 188. In other words, in the modification illustrated in FIG. 16, each divided holding member 610 is caused to hold one core 121. In the modification, the path of eddy currents can be interrupted by a divided surface of the divided holding member 610. Accordingly, dissipation due to eddy currents can be further reduced than the substantially ring-shaped holding member 110 that is integrally formed. The number of divisions is not limited to the case of agreeing with the number of the cores 121.

(2) As a combination example of the above embodiments, the snap ring 330 substantially the same as the one in the third embodiment may be firmly fixed on the core 121 of the first embodiment where the fitting grooves 225 are not formed to fit the protruding portions 112 into the fitting grooves 333a of the snap ring 330. In this case, surfaces of the snap ring 330 that come into contact with the core 121 are flat, and the fitting convex portions 333b described in the third embodiment are omitted. There is no need to form the fitting grooves 225 on the core 121. Therefore, it is possible to form the core 121 using an amorphous foil strip that is thinner than a magnetic steel sheet and the like and is difficult to process due to its hardness. If the core 121 formed of amorphous foil strips is adopted, energy loss (hysteresis loss) can be reduced compared with the core 121 formed by laminating magnetic steel sheets, which is suitable.

(3) The above embodiments are described taking the example where eight magnets 152 are provided to each rotor 150, and nine cores 121 constituting the stator 120 are provided. However, the present invention is not limited to the example. The number of the magnets 152 and the number of the cores 121 can be freely set.

(4) The type of motor is not limited to the above embodiments. For example, a switched reluctance motor (SR motor) including a rotor having salient poles may be adopted instead of the magnets 152.

(5) The cores 121 and 221 are not limited to being formed of electromagnetic steel sheets or amorphous foil strips. For example, the cores 121 and 221 may also be formed of a soft magnetic material such as a dust core.

(6) The fifth embodiment is described taking the example where the shank 561 of the bolt 560 is inserted from the outside of the center bracket 182 through the through hole of the center bracket 182, the through hole 519 of the holding member 110, the through hole of the snap ring 330, and the through hole 529 of the core 221. However, the present invention is not limited to the example. The shank 561 of the bolt 560 may be inserted from the inside of the center bracket 182 through the through hole 529 of the core 221, the through hole of the snap ring 330, the through hole 519 of the holding member 110, and the through hole of the center bracket 182 to attach the nut 563 from the outside of the center bracket 182.

(7) The above embodiments are described taking the example where the core 121 is cuboid. However, the present invention is not limited to the example. For example, a fan-shaped core 121 may be formed by winding a magnetic sheet into a roll to create a wound core, and cutting the wound core in such a manner as to divide the wound core in the circumferential direction. In this case, the opening 114 also has a fan shape and the core 121 is inserted into the opening 114 of the holding member 110 in the axial direction, which enables the core 121 to be attached to the holding member 110.

(8) The third and fifth embodiments are described taking the example where the fitting grooves 333a are provided on the snap ring 330. However, fitting grooves may be provided on a bobbin (not illustrated) around which the divided coils 122a and 122b are wound instead of the snap ring 330 to fit the circumferential outer edges 112e of the protruding portions 112 into the fitting grooves.

(9) In the first embodiment, although not illustrated, protruding portions protruding outward may respectively be provided on the side surfaces 121s of the core 121 and engaged with the holding member 110 to enable positioning.

(10) As illustrated in FIG. 13, the fourth embodiment is described taking the example where the mold body 440 is formed such that the distal ends 112a of the protruding portions 112 protrude from the inner peripheral surface of the mold body 440. However, the present invention is not limited to the example. The mold body 440 may be formed so as to cover the distal ends 112a.

The present invention is not limited to the above embodiments unless the features of the present invention are damaged. Other embodiments conceivable within the scope of the technical idea of the present invention are also included within the scope of the present invention.

What is claimed is:

1. An axial gap rotating electric machine comprising:
a pair of rotors fixed to a rotating shaft;
a stator between the pair of rotors;
a holding member holding the stator; and
a housing for housing the pair of rotors, the stator, and the holding member, wherein
the stator includes a plurality of cores arranged in a circumferential direction of the rotating shaft, and coils wound around the cores,
the holding member and the housing are conductive,
the holding member includes an outer peripheral portion firmly fixed on an inner wall of the housing, and a protruding portion protruding from the outer peripheral portion toward the rotating shaft,
the protruding portion includes a plurality of protruding portions in the circumferential direction of the rotating shaft,
the core is held by a pair of the protruding portions adjacent in the circumferential direction of the rotating shaft, and
a gap to interrupt a path of eddy currents between distal ends of the pair of the protruding portions is provided between the distal ends.

2. The axial gap rotating electric machine according to claim 1, wherein fitting grooves into which the pair of the protruding portions are to be fitted are formed on the core.

3. The axial gap rotating electric machine according to claim 1, wherein an insulating member having insulating properties is arranged between the core and the protruding portions.

4. The axial gap rotating electric machine according to claim 3, wherein
the core is held by the pair of the protruding portions via the insulating member, and
fitting grooves to be fitted with the pair of the protruding portions are formed on the insulating member.

5. The axial gap rotating electric machine according to claim 1, wherein the plurality of cores is integrally molded with resin.

6. The axial gap rotating electric machine according to claim 5, wherein the outer peripheral portion of the holding member is provided with a through hole penetrating in the axial direction of the rotating shaft.

7. The axial gap rotating electric machine according to claim 1, further comprising a fastening member including a shank penetrating the core, the holding member, and the housing in a radial direction of the rotating shaft, and a pair of retaining portions provided at both ends of the shank, wherein the core, the holding member, and the housing are fastened by the pair of retaining portions.

8. The axial gap rotating electric machine according to claim 1, wherein the holding member is divided into a plurality of parts in the circumferential direction of the rotating shaft.
